(19) United States
(12) Patent Application Publication
(10) Pub. No.: US 2007/0116248 A1
(43) Pub. Date: May 24, 2007

(54) Terminal and server for the synchronisation of contact data

(75) Inventor: Thierry Samama, Paris (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING INC., PRINCETON, NJ (US)

(21) Appl. No.: 10/560,667

(22) PCT Filed: Jun. 4, 2004
(86) PCT No.: PCT/FR04/50217

§ 371 Date: Dec. 14, 2005

(30) Foreign Application Priority Data
Jun. 20, 2003 (FR) 03 07462

(51) Int. Cl. H04M 1/00; H04M 3/00

(52) U.S. Cl. 379/355.04

(57) ABSTRACT

The invention relates to a fixed-telephony terminal comprising a telephone directory and means for transmitting and receiving SMS messages. The terminal comprises: means for converting telephone directory data into SMS messages in order to transmit them to a server, and/or means for receiving SMS messages from the server, representing directory data, and means for converting these received SMS messages into directory entries. In one embodiment, the terminal comprises means for requesting automatic synchronization or manually-controlled synchronization of the directory.

The invention relates to a system for synchronizing content data, in particular names and telephone numbers, between terminals of various types.

Electronic address books or telephone directories are now in common usage in both the private and business domains. Generally, the user has a plurality of databases of this type: on his computer, mobile phone, fixed telephone and electronic diary or personal assistant. It is, of course, preferable for a modification made to an address book on one of the terminals to be relayed in a simple manner to the other terminals. This operation is generally referred to as synchronization.

This synchronization is commonplace for mobile phones, computers and personal assistants. It is carried out, for example, according to a standard known as “SyncML”, which is independent of the transmission means, or according to proprietary interfaces (for example “HotSync” for personal assistants under the “PalmOS” operating system), or according to interfaces linked to the transmission means (for example infrared or “BlueTooth” short-range wireless).

The invention results from the finding that no means exists which enables synchronization of directories on fixed telephones and this absence of means results from the fact that synchronization requires memory capacities and processing means which are not generally provided in fixed telephones. Moreover, since the cost of fixed-telephony terminals is low, the addition of means permitting synchronization runs the risk of increasing the price of these terminals in a prohibitive manner.

Furthermore, existing synchronization means, such as the SyncML standard, require a bandwidth and processing power which exceed the current capacities of fixed telephones.

The invention eliminates these disadvantages.

A fixed-telephony terminal according to the invention is characterized in that, to enable synchronization of its directory with the data originating from a server, said terminal is of the type comprising means for transmitting and receiving SMS messages (“Short Message Service”) and comprises means for receiving SMS messages originating from the server containing the synchronization data of the directory and means for transmitting to the server data relating to its directory, or to modifications of the directory, in order to enable synchronization of other terminals with this directory, or backup of this directory.

Use of the SMS channel for synchronization of a fixed telephone enables minimization of the bandwidth used. Moreover, the memory capacity to be used is close to that which already exists for reception and transmission of SMS messages. Compared with a conventional fixed-telephony terminal, the only additional processing is the transformation of the received SMS messages into the format of the directory of the terminal and, conversely, the transformation of the directory data into SMS messages to be transmitted. However, this involves conversion means which can be implemented at low cost. For example, if the terminal already comprises a microprocessor, these processing means will involve virtually no additional cost.

It may be necessary to provide an additional memory to store the software which enables conversion of SMS messages into numbers for the telephone directory and vice versa. However, this additional capacity is relatively small.

The server with which the fixed-telephony terminal communicates, and which can be connected to other devices for synchronization, is preferably compatible with the SyncML standard.

The invention therefore also relates, in a manner independent from a terminal, to a server which comprises inputs/outputs to receive address directory data from or to transmit address directory data to computer, personal assistant, or mobile telephone terminals, and at least one input/output intended to transmit directory synchronization SMS messages to fixed-telephony terminals, and/or to receive such SMS messages representing directory synchronization data originating from fixed-telephony terminals.

In one embodiment, the server comprises means for selecting the directory data to be transmitted to the fixed-telephony terminals from complete address book data. In a more precise manner, in one embodiment, the directories contained in the fixed-telephony terminals contain only a name field and a telephone number field, whereas the address books contained in the database of the server contain a larger number of fields such as, in addition to the name and telephone number, the first name, postal address, e-mail address and other characteristics of the person concerned.

Thus, in a general manner, the invention relates to a fixed-telephony terminal comprising a telephone directory and means for transmitting and receiving SMS messages, characterized in that it comprises:

means for converting data from the telephone directory into SMS messages in order to transmit them to a server, and/or

means for receiving SMS messages from the server representing directory data, and means for converting these received SMS messages into directory entries.

The telephone directory is preferably attached to an SMS subaddress, each SMS subaddress being accessible via an access code.

In one embodiment, the terminal comprises means for addressing the characteristics of its directory, i.e. the maximum number of entries, the entry format and, preferably, the number of directories, via SMS messages, to the server to which it can be connected.

The terminal may comprise means for requesting automatic synchronization or manually controlled synchronization of the directory.

According to one embodiment, the terminal comprises a memory containing the modifications made to the directory and means for indicating the need for synchronization, or for automatically initiating synchronization, if the level of fullness of the memory exceeds a predetermined threshold, or if a predetermined period of time has elapsed since the last synchronization.

In one example, the terminal comprises a means for receiving, from a server to which it is connected, a signal indicating that synchronization must be carried out.

In this case, a means may be provided so that the synchronization is carried out automatically when the signal is received.

The terminal preferably comprises a means for receiving, from a server to which it is connected, modification data, and means for updating the directory with these modification data.

The invention also relates to a server comprising:

at least one SMS communications interface, such as with an F-SMSC server, with fixed-telephony terminals for the reception from and transmission to said terminals of the data relating to their telephone directories,

inputs/outputs which can be connected to the Internet network for the reception from and transmission to computer, personal assistant or mobile telephone devices or other synchronization server, of the telephone directory or address book data, and,

for each user, a directory database enabling synchronization of the data from a directory of the fixed-telephony terminal user with the other types of terminal which can be connected to the Internet network, and/or enabling backup of the data from a directory of fixed-telephony terminal users.

In one embodiment, the server comprises an input for its link to an Internet site so that the user can populate the database from a browser.

The telephone directory or address book data are preferably accessible according to the SyncML standard.

According to one embodiment, the server comprises means for formatting the directory data according to the characteristics of the fixed-telephony terminals.

In this case, the formatting means may comprise means for selecting the directory data from address book data.

In one embodiment, the server comprises means for automatic transmission to a fixed-telephony terminal of the directory modifications if the number of bytes of this modification exceeds a predetermined threshold, or if a predetermined period of time has elapsed since the last synchronization.

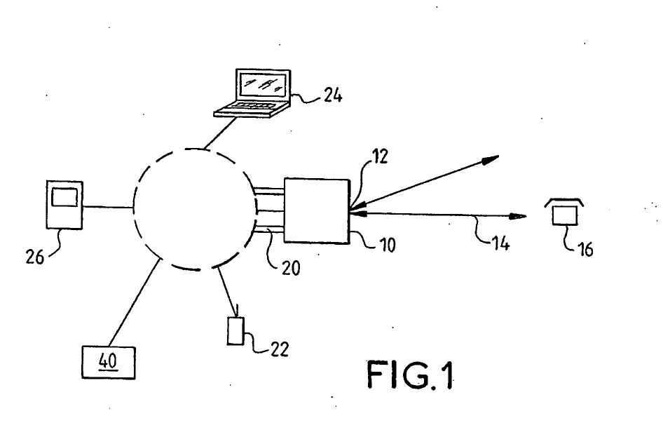

Other characteristics and advantages of the invention will become evident from the description of some of these embodiments, said description being provided with reference to the attached drawing, in which FIG. 1 shows a system according to the invention.

The system according to the invention, which is shown in FIG. 1, comprises a server 10 with an input/output 12 intended to be connected via a fixed-telephony network 14 to wired or wireless fixed-telephony terminals 16. In practice, the server 10 is connected to the network 14 via an F-SMSC (Fixed SMS Center) server.

Moreover, the server 10 can be connected to the Internet network via, for example, a SyncML interface, in order to receive and broadcast telephone directory or address book data. These data originate from or are transmitted to mobile telephones 22, computers 24 and personal assistants 26 (PDA “Personal Digital Assistant”), possibly via other synchronization servers.

The telephones 16 are SMS telephones, i.e. they can transmit and receive SMS messages. For the transmission and reception of SMS messages, each telephone terminal 16 comprises a subaddress in order to be able to distinguish this terminal from a different terminal connected to the same line, i.e. having the same call number. A plurality of subaddresses corresponding to different users can also be assigned to each terminal. In this case, an input code is assigned to each subaddress.

The terminal 16 comprises a telephone directory, means for converting the data from this directly into SMS messages and means for transmitting this telephone directory via SMS messages to the server 10. It also comprises means for receiving SMS messages from the server 10, representing data from the directory, and means for converting these SMS messages into entries in the directory.

The terminal 16 furthermore comprises a means for registering with an operator or service provider, in order to make use of the telephone directory synchronization service. The registration is carried out in three steps, i.e.: an identification step, a data input step, and an initial synchronization step. The first two steps are carried out via communication which does not involve the terminal 16.

During the identification step, the user addresses his identification data, i.e. the telephone number of the line to which the terminal 16 is connected and the SMS subaddress of the terminal 16, to an Internet site 40 of the operator or service provider. This operation is carried out via direct access, for example via a computer or personal assistant, to the Internet site 40, which is itself connected to the server 10.

In return, the site 40 provides the user with an access code.

The second step, which is also carried out independently of the terminal 16, consists in entering contact data with the aid of an Internet form. These content data are the different fields found in an address book, i.e.: the name, first name, postal address, e-mail address, telephone number, fax number, etc. Thus, the server 40 will contain address book data and will be capable of selecting, from these data, the data which can be loaded via SMS messages onto the fixed-telephony terminals.

This data input step also comprises the possibility of authorizing access to identified devices such as the computer or personal assistant or mobile telephone of the same user. This data input may also comprise the assignment of different directory categories, for example a personal directory and a business directory.

The third step is the initial synchronization step. It consists in transferring data from the server 10 to the terminal 16. To do this, the user chooses the initial synchronization menu on the terminal. The terminal first requests the access code. If the telephone line is free, the terminal then automatically sends an SMS message to the server 10, containing, on the one hand, the calling line number, i.e. the telephone number of the terminal 16 and the SMS mailbox subaddress, the access code of the user and the characteristic data of the terminal 16. These characteristic data are the maximum number of entries in the directory, the entry format, i.e. the number of characters in the name field (and possibly the field of other data such as the business or home address), the number of symbols in the number field and the number of directories.

If the access code of the user does not match that of the terminal line and the SMS subaddress, the server responds with an SMS message indicating an error. This error message may indicate, for example, that the access code does not match that of the telephone line 16, or that the line does not subscribe to the service.

If the access code is correct, the server 10 carries out the formatting of the directory of the terminal 16 on the basis of the characteristics of this terminal, and transmits the telephone directory to said terminal in the form of concatenated and verified SMS messages, for example through summation. As indicated above, the formatting comprises, where appropriate, selection of the data to be transmitted from the server 10 to the terminal 16. In one embodiment, the server transmits only the name field and the telephone number field to the terminals 16.

When the terminal has correctly received the information, it automatically sends a confirmation message to the server containing the number of entries received and the required subsequent synchronization mode, i.e. automatic mode, manual mode or non-synchronization mode. Non-synchronization mode means that the downloaded directory will no longer be updated.

The initial synchronization may also consist in sending the directory data from the terminal to the server. In this case, the terminal sends its characteristics at the same time as the directory data.

The subsequent synchronization consists in the transmission from the server to the terminal, or from the terminal to the server, of modification data comprising directory data additions, deletions or changes.

According to one embodiment, each modification which is made in the server or in the terminal is transmitted as soon as possible to the other party (terminal or server) in the form of (an) SMS message(s).

In a different embodiment, the SMS synchronization messages are transmitted only if all of the modifications made attain a determined size, in order to minimize cost and transmission time. For example, if the required size corresponds to a determined number of bytes (typically the maximum number of bytes in an SMS message), the terminal (or the server) comprises means for counting the number of bytes of the modifications and for initiating the SMS connection once the sum of the modifications has attained a determined size. This linkage may be carried out through detection of the fullness of a memory into which the modifications are entered.

In a different embodiment, the SMS synchronization messages are transmitted only if a predetermined period of time has elapsed since the last modification. This enables a series of modifications carried out by the user during a single session to be taken into account.

These embodiments may also be combined to initiate the automatic dispatch of messages as soon as one of these criteria (size or duration) has been satisfied.

Each synchronization message comprises the user access code and the sender is identified thanks to his call number and possible SMS subaddress.

The synchronization may also be performed, manually. In this case, each synchronization is carried out only at the request of the user. For example, the terminal comprises means for determining the modifications made after each synchronization and, if the capacity or size of these modifications exceeds a predetermined value, a signal indicates to the user that he must perform synchronization. An additional modification is not possible until the synchronization has been carried out, since the modifications memory is full. The user can also request manual synchronization from the terminal, even if the modifications memory is not full.

Manual synchronization from the server to the terminal can be initiated at the request of the user, this request being submitted via the Internet site 40.

Forced synchronization is a retransmission, identical to the initial synchronization, which consists in retransmitting, for example following an incident, the directory data from the terminal to the server or from the server to the terminal. For a terminal, an incident which may result in loss of or damage to the directory is, for example, a power cut, user error or automatic synchronization failure. In the case of the server, loss of or damage to the directory may originate either from a user error or an error in the server or an automatic synchronization fault.

This forced synchronization may be initiated from the terminal or from the server.

The system according to the invention enables the provision of terminals at virtually the same cost as standard SMS-enabled terminals, since these terminals only require an additional memory capacity in the order of several kbytes. The processing means are already available in the terminals, since the latter generally comprise a microcontroller.

Furthermore, the system according to the invention does not require a specific communications channel, since the invention makes use of the SMS fixed-line protocol which is currently standardized by ETSI and is available in most networks of major European operators and some non-European operators.

Thus, the possibility of synchronizing the directories of (wired or wireless) fixed-telephony terminals with all types of devices, in particular those that are compatible with the SyncML standards is obtained in a simple manner and at low cost.

For the same subscriber, the use of SMS fixed-telephony terminals enables the existence and separate synchronization of a plurality of directories thanks to distinct SMS addresses. This existence of distinct SMS addresses also enables the confidentiality of each of the SMS addresses.

In a general manner, the directory of a fixed telephone can be set up, thanks to the invention, from a different device or terminal on which information can be entered more easily than with a telephone terminal. The other terminal is, for example, a keyboard device comprising all the letters of the alphabet, or a personal assistant on which it is possible to write manually. The directories of fixed and mobile telephones can also be synchronized. Finally, the server may serve as a backup to the directory.

It must be noted that the connection, via SMS messages, to an Internet site 40 enables guidance of the user of the fixed telephone on his screen.

The protocol for communication between the server and terminals is preferably such that it comprises error correction codes and procedures for retesting in the event of errors.

As a variant, one-way synchronization is provided from the server 10 to the telephone 16, i.e. the invention is then used only to enter and modify contact information in a more user-friendly manner than with the telephone. In this case, it will suffice that the terminals are equipped with means for converting received SMS messages into directory data, but it is not indispensable for the terminals to comprise means for transforming directory data into SMS messages.

In a different variant, the synchronization is asymmetrical, i.e. it is essentially performed from the terminal 16 to the server, which is used as a directory backup means. In the event of loss of data in the terminal directory, recovery is carried out through forced synchronization from the server to the terminal.

1. A fixed-telephony terminal, comprising a telephone directory and means for transmitting and receiving SMS messages, wherein it comprises:
means for converting data from a telephone directory into SMS messages in order to transmit them to a server, and/or
means for receiving SMS messages from the server, representing directory data, and means for converting these received SMS messages into directory entries.

2. The terminal as claimed in claim 1, wherein the telephone directory is attached to an SMS subaddress, each SMS subaddress being accessible via an access code.

3. The terminal as claimed in claim 1, wherein it comprises means for addressing the characteristics of its directory, i.e. the maximum number of entries, the entry format, and, preferably, the number of directories, via SMS messages, to the server to which it can be connected.

4. The terminal as claimed in claim 1, wherein it comprises means for requesting automatic synchronization or manually-controlled synchronization of the directory.

5. The terminal according to claim 1, wherein it comprises a memory containing the modifications made to the directory and means for indicating the need for synchronization, or for automatically initiating synchronization, if the level of fullness of the memory exceeds a predetermined threshold, or if a predetermined period of time has elapsed since the last synchronization.

6. The terminal as claimed in claim 1, wherein it comprises a means for receiving, from a server to which it is connected, a signal indicating that synchronization must be carried out.

7. The terminal as claimed in claim 6, wherein comprises a means so that the synchronization is carried out automatically when the signal is received.

8. The terminal as claimed in claim 1, wherein it comprises a means for receiving modification data, from a server to which it is connected, and means for updating the directory with these modification data.

9. A server, comprising:
at least one SMS communications interface, such as with an F-SMSC server, with fixed-telephony terminals for the reception from and transmission to said terminals of data relating to their telephone directories,
inputs/outputs which can be connected to the Internet network for the reception from and transmission to computer, personal assistant or mobile telephone devices or other synchronization server, of telephone directory or address book data, and,
for each user, a directory database enabling synchronization of the data from a directory of the fixed-telephony terminal user with the other types of terminal which can be connected to the Internet network, and/or enabling backup of the data from a directory of fixed-telephony terminal users.

10. The server as claimed in claimed in 9, comprising an input for its link to an Internet site so that the user can populate the database from a browser.

11. The server as claimed in claim 9, in which the telephone directory or address book data are preferably accessible according to the SyncML standard.

12. The server as claimed in claim 9, comprising means for formatting the directory data according to the characteristics of the fixed-telephony terminals.

13. The server as claimed in claim 12, wherein the formatting means comprise means for selecting the directory data from address book data.

14. The server as claimed in claim 9, comprising means for automatic transmission to a fixed-telephony terminal of the directory modifications if the number of bytes of this modification exceeds a predetermined threshold, or if a predetermined period of time has elapsed since the last synchronization.
